(19) United States
(12) Patent Application Publication
(10) Pub. No.: US 2009/0142161 A1
(43) Pub. Date: Jun. 4, 2009

(54) Screw Anchor

(76) Inventor: Ulrich Hettich, Schramberg (DE)

Correspondence Address: Durane Morris, 505 9th Street N W Suite 1000, Washington, DC, 20004, US

(21) Appl. No.: 12/084,123

(22) PCT Filed: Apr. 20, 2007
(86) PCT No.: PCT/EP2007/003503

§ 371 Date: Apr. 25, 2008

(30) Foreign Application Priority Data
May 24, 2006 (DE) 10 2006 024 440.0

(51) Int. Cl. F16B 5/02

(52) U.S. Cl. 411/413

(57) ABSTRACT

A screw anchor for fastening wooden construction parts on concrete or masonry comprises a shaft having a first threaded portion with a wood screw thread to be screwed into wood and a second threaded portion with a concrete thread to be screwed into concrete, the wood screw thread having the same or a somewhat smaller pitch than the pitch of the concrete thread.

The invention relates to a screw anchor for fastening wooden construction parts on concrete or masonry.

It is known in the art to fasten wooden construction parts on concrete or masonry by using anchors which transmit the loads from the wooden construction part to the concrete by mechanisms of action which are generally known as “compound arrangements”, “undercuts”, “spreading cones”, and “threads”. A screw anchor essentially is a steel part which is glued into concrete, while the connection with the wooden construction part, as a rule, is obtained via a head or a nut. Load trans-mission through an undercut refers to the provision of a geometric undercut in concrete produced by a drilling procedure or by the anchor itself, an expansion element being inserted into the resulting undercut for transmission of tractive loads of the anchor. A spreading cone anchor is based on a similar principle of tractive load transmission, the expansion element of this anchor being directly integrated in the anchor. Finally, a screw anchor has a threaded portion formed with a concrete thread to be screwed directly into concrete. This threaded portion is followed by a threadless shaft which passes through the wooden construction part placed on the concrete surface and terminates at a screw head, the underside of which abuts against the surface of the wooden construction part when the screw anchor is in its screwed-in state.

Transmission of the tensile load from the wooden construction part to the anchor takes place through the abutment of the head thereof, transverse loads are transmitted through the inside of the hole or bearing and pressing, respectively, along the smooth shaft of the anchor inside the wooden construction part.

In the prior art, metal discs are inserted between the head of the anchor and the wooden construction part in order to increase the amount of tensile load acting on the wooden construction part which the anchor can accommodate. However, if the tensile load potential of the anchor resulting from its anchoring in the concrete is to be exploited rather great and thick metal discs are needed for transmitting corresponding great tensile loads to the wooden construction part. For example, if an anchor having a diameter of 12 mm were used, and the metal disc inserted had a diameter of 30 mm and a thickness of 4 mm, there still could be a risk that the metal disc would deflect under tensile loads which the anchoring of the anchor in concrete still could withstand quite well.

The transmission of transverse loads to the anchor is limited substantially by the bending stress to which the anchor is subjected due to these transverse loads. The bending stress which results from loading of the wooden construction part parallel to the concrete wall or masonry increases with increasing thickness of the wooden construction part, and the admissible transverse loading of the connection decreases with increasing thickness of the wooden construction part, respectively. It is accepted that the lever arm for the transmission of transverse loads corresponds to half the thickness of the construction part. With customary wooden construction parts of up to 240 mm in thickness and more, therefore, the lever arm corresponding to half the thickness of the construction part would be so big that the usual anchors will not be able, normally, to cope with the transverse forces to be expected, unless further measures are taken. So-called “dowels of special design” are known in the art to relieve the anchor from the bending stress. They are introduced into the wooden construction part at the side thereof facing the concrete or masonry. In this manner it is assured that the transverse loads acting in the joint between the concrete and the wooden construction part will be introduced into that part of the anchor which is anchored in the concrete, whereby the anchor as a whole is not subjected to bending stress. “Dowels of special design”, in general, are to be understood as disc-like, serrated steel members which have a bore and are beaten into the wooden construction part.

Another possibility known in the art for fastening wooden construction parts on concrete or masonry are connectors made of steel which are mounted on the outside of the concrete. They are fixed in the concrete by anchors and in the wood by means of nails or screws. These connections have the disadvantage of being expensive to install and not very pleasant to look at.

U.S. Pat. No. 6,022,177 A discloses a spacer screw for fastening a construction part with a certain distance on a wooden support. The spacer screw comprises two threaded portions having, in principle, equal threads and being separated by a shaft portion without a thread. Near the head, the thread of the threaded portion is provided with slits to generate a defined resistance to the screwing-in action. Both threads either may have the same pitch or different ones.

A screw for fastening wooden construction parts on a wooden base without a spacing in between is known from DE 203 19 768 U1. It comprises two threaded portions which are separated by a shaft portion without thread. The pitch of the threaded portion near the head is clearly smaller than the pitch of the threaded portion which enters the wooden base. It is stated to be an advantage to have the greatest possible difference in pitch between the threaded portions. The threads of the two threaded portions at least have approximately the same outer diameters.

It is the object of the invention to provide a screw anchor of the kind defined initially which comprises fewer elements than the known anchors and fulfills the high demands as to load carrying capacity in respect of tensile and bending strains and transverse loading better than conventional anchors.

A screw anchor according to claim 1 is provided to resolve that problem. Advantageous embodiments of the invention are indicated in the subclaims.

The screw anchor according to the invention can do without the disc under the head abutment and also without the use of “dowels of special design”. At the same time, the tensile and transverse load carrying capacity of the connection is clearly improved. The screw anchor consists of but one part and its production is simple.

The invention will be described further, by way of example, with reference to diagrammatic drawings, in which:

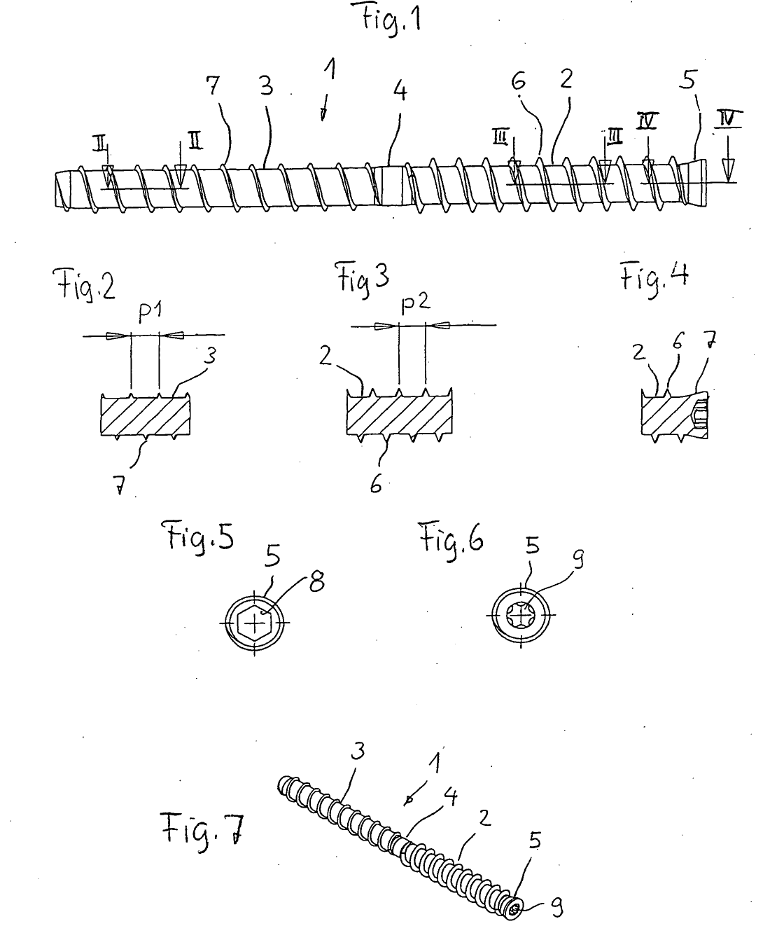

FIG. 1 is a side elevational view of a screw anchor according to the invention;

FIGS. 2, 3, and 4 are part sectional views along lines II-II, III-III, and IV-IV, respectively, in FIG. 1;

FIGS. 5 and 6 are head-on views of two different embodiments of a screw anchor according to the invention;

FIG. 7 is a perspective view of a screw anchor according to the invention.

An embodiment of a screw anchor according to the invention is illustrated in the figs. The screw anchor 1 has a wood threaded portion 2 and a concrete threaded portion 7 which are interconnected by shaft portion 4 without thread. This shaft portion 4 has a diameter which is somewhat greater than the core diameter of both threaded portions 2 and 3. The thread 6 on the wood threaded portion is a conventional wood screw thread having a pitch p2, as shown in FIG. 3. The thread 7 on the concrete threaded portion 3 is designed for direct screwing of the screw anchor into concrete, for instance, according to EP 0 623 759 B1 or EP 1 127 222 B1.

At its free end, the screw anchor has a conical head portion 5 having a small cone angle so that the screw anchor pulls itself in when it is screwed into wood. The head portion 5 is formed with a recess having the shape of a hexagonal recess 8 (FIG. 5) or a hexagon round recess (FIG. 6) for a corresponding screw driver.

These actuators are examples and other known internal actuators may be provided as well.

The screw anchor according to the invention is special in that it can be mounted by a kind of bolt setting method being fully countersunk in the wooden construction part. The pitch p2 throughout the wood threaded portion may be the same as the pitch p1 throughout the concrete threaded portion. Preferably, however, the pitch p2 in the wood threaded portion 2 is a little smaller that the pitch p1 in the concrete threaded portion. The somewhat smaller pitch makes sure that the wooden construction part is pressed against the concrete surface.

The diameter of the wood screw thread 6 is greater than the diameter of the concrete screw thread 7. That results in a higher extraction load of the screw anchor according to the invention in the wooden construction part.

The increase in tensile loadability of the anchor in comparison with the prior art is the result of the higher load bearing capacity of the wood thread as against the bearing strength of the head passage or head support of the known anchors. It is another advantage of the screw anchor according to the invention that it may be embedded in the wooden construction part, in other words, it need not be as long as the thickness of the wooden construction part. That makes the screw anchor more versatile for use.

The higher transverse load bearing capacity substantially results from the distinctly shorter structural length in comparison with known anchors. Hereby, the bending stress is greatly reduced to which the anchor as a whole is subjected. The screw anchors according to the invention can be shorter than conventional anchors because the head abutment is not needed to accommodate transverse loads and, therefore, the head may be countersunk in the wooden construction part. The shorter structural length at the same tensile loading capacity is offered by the double thread design according to the invention. The embedded length of the anchor in the wooden construction part, furthermore, may be utilized to influence the relationship between the admissible transverse loading and the admissible tensile loading of the connection. For example, let us consider an anchor according to the invention having a diameter of 12 mm. At a length of 60 mm, such an anchor can carry a theoretically admissible tensile load of approximately 4.2 kN and a transverse force of approximately 1.9 kN. With a reduced length of 40 mm and otherwise the same construction, the theoretically admissible tensile load drops to about 2.8 kN, while the admissible transverse force rises to about 2.4 kN. The figures mentioned in this example serve to illustrate the principle of the invention; it cannot be excluded that deviations from the figures may occur, depending on the specific realization of the anchor according to the invention.

For comparison, if one looks at a known anchor of the same size (12 mm diameter) used in combination with a wooden construction part of “typical” thickness, the admissible transverse load bearing capacity of the anchor is 1.1 kN for a wooden construction part whose thickness, for instance, is 120 mm. For a thickness of 240 mm of the wooden construction part, the admissible transverse load bearing capacity is 0.6 kN. The lower load bearing capacity substantially is due to the greater structural length of the known anchor, required because with this kind of anchor the transverse load is received mainly by the head support.

The features disclosed in the specification above, in the claims and drawings may be significant for implementing the invention in its various embodiments, both individually and in any combination.

1. A screw anchor for fastening wooden construction parts on concrete or masonry, comprising a shaft having
a first threaded portion with a wood screw thread to be screwed into wood and
a second threaded portion with a concrete screw thread to be screwed into concrete,
the wood screw thread having a somewhat smaller pitch than the pitch of the concrete thread so that, in screwed-in state, the wooden construction part is pressed against the concrete surface, and
the diameter of the wood screw thread being greater than the diameter of the concrete screw thread.

2. The screw anchor as claimed in claim 1, characterized in that a short shaft portion without thread is provided between the two threaded portions, this thread portion having a diameter greater than the core diameters of the two threaded portions and bridging the joint which separates the wooden construction part and the concrete.

3. The screw anchor as claimed in claim 1, characterized in that a head portion provided at the free end of the threaded portion for wood is formed with a recess to receive a tool for screwing the screw anchor in and out.

4. The screw anchor as claimed in claim 3, characterized in that the recess is a hexagonal recess.

5. The screw anchor as claimed in claim 4, characterized in that the recess is a hexagon round recess.

6. The screw anchor as claimed in any one of claims 3, characterized in that the head portion is shaped like a truncated cone having a small cone angle.

7. The screw anchor as claimed in any one of claims 1, characterized in that the ratio of the pitch of the wood screw thread to the pitch of the concrete screw thread is approximately 3.4:3.5.
